(19) United States
(12) Patent Application Publication
(10) Pub. No.: US 2005/0036029 A1
(43) Pub. Date: Feb. 17, 2005

(54) Imaging head with laser diode array and a beam-shaping micro light-pipe array

(76) Inventors: Nissim Pilossof, Rehovot (IL); Igal Koifman, Hadera (IL); Alex Weiss, Kadima (IL)

Correspondence Address: Eitan Pearl;Latzer & Cohen Zedek, Suite 1001, 10 Rockefeller Plaza, New York, NY, 10020, US

(21) Appl. No.: 10/450,660

(22) PCT Filed: Nov. 18, 2001
(86) PCT No.: PCT/IL01/01061

Related U.S. Application Data
(60) Provisional application No. 60/254,546, filed on Dec. 12, 2000.

(51) Int. Cl. B41J 2/45

(52) U.S. Cl. 347/241

(57) ABSTRACT

An optical imaging heads that produce a plurality of light spots on light sensitive media such as photographic film or printing plate. The optical head incorporates an array of multi-mode laser diodes as a light source, a Micro Light-Pipe Array (MLPA) as a beam-shaping element, means for reducing the divergence of the laser diode beam in the fast axis direction and means for imaging the laser diode emitters on a surface close to the micro light-pipe entrance aperture.

### FIELD OF THE INVENTION

The present invention relates to optical imaging heads that produce a plurality of light spots on light sensitive media such as photographic film or printing plate. The optical head incorporates an array of laser diodes as light source and a Micro Light-Pipe Array (MLPA) as a beam-shaping element.

### BACKGROUND OF THE INVENTION

Optical heads for imaging a plurality of light spots on a light sensitive media may incorporate an array of laser diodes as a light source. The laser diodes array may be configured as an ordered plurality of individual laser diodes mounted on a common carriage, or as a plurality of laser emitters manufactured on a single-piece semiconductor material (such as GaAs). For brevity, the light source (whether configured out of individual laser diodes or manufactured on a single semiconductor chip) will be referred to hereunder as Individually Addressed Laser Diode Array (IALDA).

The imaging speed in electro-optical plotters is generally limited by the power delivered to the medium by the laser beam(s). This is especially true when the imaged medium is a thermal or ablative printing plate, or laser-transfer material, where the sensitivity is typically of the order of several hundreds mJ/cm². In order to achieve the required power, the IALDA has to be built of powerful multi-mode laser diodes (LD). Multimode LDs are characterized by the light-emitting region having a very elongated shape, typically 1 micron across and 50 to 200 microns along the array axis, with the beam divergence in the cross-emitter direction high, typically 50-60 degrees FWHM, and the beam divergence in the length direction relatively low, typically 10 degrees FWHM. For brevity, the cross-emitter direction will be referred to as the ‘fast axis’ and the emitter's length direction will be referred to as the ‘slow axis’

The near field emission pattern of multi-mode LDs is substantially rectangular. An important characteristic of multi-mode LDs is that the energy distribution of the near field in the slow axis direction is non-uniform and changes with the LD's junction temperature, as well as with the data current driving the diode. This effect is often displayed as a “hot spot” moving along the emitter's length. When the image on the photosensitive medium is formed by imaging the near field of the LD, the non-uniform and frequently changing energy distribution of its pattern leads to undesired effects, such as image density irregularities. A method and apparatus for overcoming these shortcomings of multi-mode LDs by using optical diffusers is disclosed in EP 0 992 343 A1 to Sousa U.S. Pat. No. 6,208,371 to Takeshi et al, describes an optical beam-shaping system imaging the near field of a LD.

The present invention successfully solves the above mentioned shortcomings of imaging the multi-mode LD near field, by using a Micro-Light-Pipe Array (MLPA) for achieving spots with evenly distributed energy on the photosensitive medium, not depending on the LD's working conditions.

### SUMMARY OF THE INVENTION

It is an object of the present invention to provide a multiple laser-beam recording apparatus producing a plurality of high-degree identical optical spots with uniform energy distribution.

Another object of the present invention is to provide a multiple laser-beam recording apparatus, which is free of image density irregularities due to non-uniform energy distribution of the LD near field.

Still another object of the present invention is to provide a high energy-efficient multiple laser-beam recording apparatus free of image density irregularities due to non-uniform energy distribution on the LD near field.

### BRIEF DESCRIPTION OF THE DRAWINGS

FIG. 1a is a schematic isometric view of an IALDA and a beam-shaping MLPA according to the present invention;

FIGS. 1b and 1e schematically illustrate an exemplary optical imaging head incorporating the IALDA and beam-shaping MLPA of FIG. 1a;

FIG. 2a is a schematic isometric view of an IALDA with an anamorphic correcting lens and a beam-shaping MLPA according to the present invention;

FIGS. 2b and 2c schematically illustrate an exemplary optical imaging head incorporating the IALDA with anamorphic correcting lens and beam-shaping MLPA of FIG. 2a;

FIG. 3a is a schematic isometric view of an IALDA with a correcting and imaging lens system with virtual emitter image and a beam-shaping MLPA according to the present invention;

FIGS. 3b and 3c schematically illustrate an optical imaging head incorporating the IALDA with correcting and imaging lens system with virtual emitter image and beam-shaping MLPA of FIG. 3a;

FIG. 4a is a schematic isometric view of an IALDA with a correcting and imaging lens system and a beam-shaping MLPA according to the present invention;

FIGS. 4b and 4c schematically illustrate an optical imaging head incorporating the IALDA with correcting and imaging lens system and beam-shaping MLPA of FIG. 4a;

FIGS. 5a and 5b show the energy distribution of light in the entrance and exit apertures of a micro light-pipe respectively;

FIG. 6a is a schematic isometric view of an IALDA and a tapered beam-shaping MLPA according to the present invention;

FIGS. 6b and 6c schematically illustrate an exemplary optical imaging head incorporating the IALDA and tapered beam-shaping MLPA of FIG. 6a;

FIG. 7a is a schematic isometric view of an IALDA with an anamorphic correcting lens and a funnel-type beam-shaping MLPA according to the present invention;

FIGS. 7b and 7c schematically illustrate an exemplary optical imaging head incorporating the IALDA with anamorphic correcting lens and funnel-type beam-shaping MLPA of FIG. 7a;

FIG. 8 is an exploded isometric view of a micro-machined MLPA;

FIGS. 9a to 9d illustrate different channel shapes in micro-machined MLPA according to the present invention;

FIG. 10 is a schematic isometric view of an IALDA and a bulk-type beam-shaping MLPA according to the present invention;

FIG. 11 is a schematic isometric view of an external-drum-type electro-optical plotter with optical imaging head incorporating an IALDA and a beam-shaping MLPA according to the present invention; and

FIG. 12 is a schematic isometric view of a flatbed-type electro-optical plotter with an optical imaging head incorporating an IALDA and a beam-shaping MLPA according to the present invention.

### DETAILED DESCRIPTION OF PREFERRED EMBODIMENTS

There are generally two types of light-pipes: Bulk and Hollow.

The bulk-type light-pipe is a rod of transparent material with a polygonal cross-section (triangular, rectangular, etc.). The index of refraction of the material forming the light-pipe is higher than the index of refraction of the surrounding material. A typical example is glass rod in air. This type of light-pipes employ the principle of Total Internal Reflection (TIR) on the interface of the two materials—in the above example on the interface glass—air.

The hollow light-pipes are tubes with a polygonal cross section (triangular, rectangular, etc.), made of transparent or nontransparent material, with their internal walls coated with a highly reflective coating. This type of light-pipes work on reflection from the reflective coating.

In all preferred embodiments described below, a hollow light-pipe is taken as an example. It will be, however, appreciated by any person skilled in the art, that same performance can be achieved by using bulk-type light-pipes.

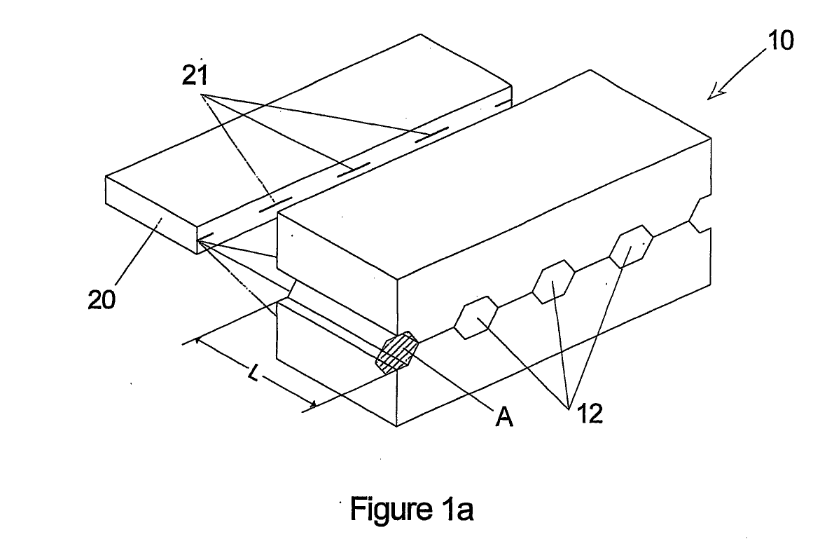

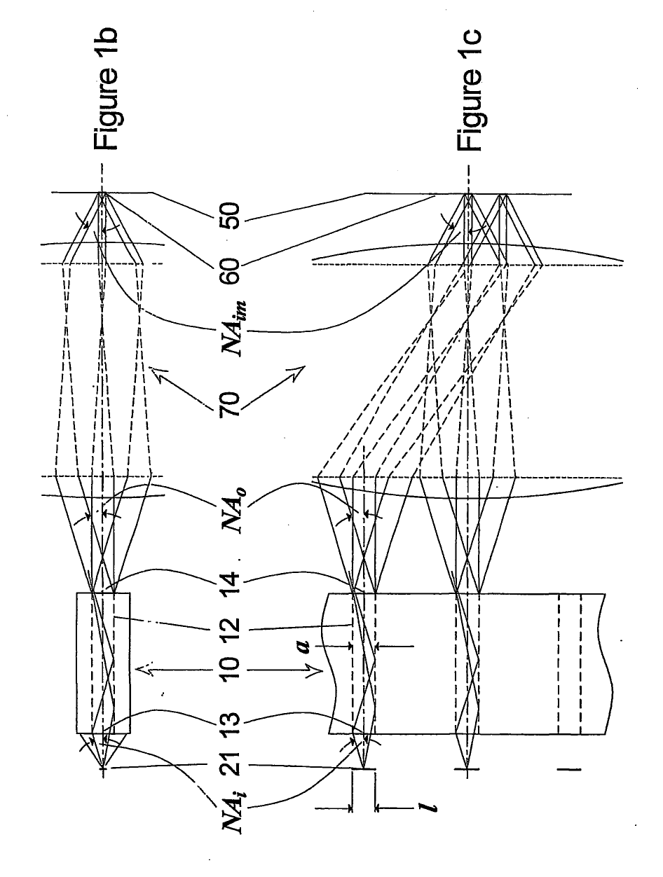

FIG. 1a shows an IALDA light source 20 and an MLPA 10, aligned in parallel with the array of laser emitters 21. The number of the channels 12 in the MLPA corresponds to the number of the laser diodes 21 in the IALDA and the MLPA is placed in close proximity to the IALDA, in order to avoid optical crosstalk between the channels. The Micro Light-Pipes (MLP) 12 are hollow and their internal surface is coated with a highly reflecting coating, such as Au, enhanced Al or dielectric, depending on the base material and the wavelength of the light. The light emitted from each diode 21 enters the corresponding MLP 12 trough its entrance aperture 13. Inside the MLP 12 each beam experiences a number of bounces from its walls before it exits from the opposite side through the exit aperture 14. Due to these multiple reflections, the illumination of the MLP exit aperture is relatively uniform The uniformity, defined as

$$\frac{Edge Illumination}{Center Illumination} ,$$

depends on the value

$${L}_{n} = \frac{L \cdot {NA}_{i}}{n \cdot \sqrt{A}} ,$$

called the MLP normalized-length, where L is the light-pipe length, NAᵢ is the numerical aperture of the input beam n is the index of refraction of the MLP (n=1 for a hollow MLP), and A is the cross-sectional area of the MLP. There is no precise theory of light pipes. The scrambling efficiency is usually checked experimentally, or by non-sequential ray tracing. It is, however, an empirical fact that when Lₙ≧4, the illumination uniformity at the MLP exit can be expected to be better than 90%.

FIGS. 1b and 1c schematically show an optical imaging head 100 incorporating an IALDA 20, represented by a limited number of emitters 21, and an MLPA 10. FIG. 1b illustrates the beams propagation in a plane coinciding with the emitters' fast axis, while FIG. 1c illustrates the beams propagation in a plane coinciding with emitters' slow axis. The exit aperture 14 of the MLPs 12 is imaged by means of imaging lens 70, preferably telecentric, on the photosensitive medium 50, i.e. the exit apertures 14 lie in the object plane of the imaging lens 70, while their images 60 lie on the photosensitive medium 50, which coincides with the image plane of lens 70. As far as all light spots 60 are images of substantially identical objects—the exit apertures 14 of the MLPs 12—they too will be substantially identical. Due to the relatively uniform illumination of the exit apertures 14, their images 60 will also feature a relatively uniform distribution of illumination. Thus, substantially identical light spots with uniform energy distribution are achieved on the medium 50.

A very important parameter of the imaging head in electro-optical plotters is the depth of focus; higher depth of focus requires lesser mechanical accuracy. The depth of focus is in direct dependence to the numerical aperture NAᵢₘ of lens 70 image plane, such that the higher NAᵢₘ, the lower is the depth of focus. The numerical aperture (NA) at the image side of lens 70 is

$${NA}_{im} = \frac{{NA}_{o}}{K} ,$$

where K<1 (usually) is the magnification of imaging lens 70 and NAₒ is the object side NA, i.e. the NA of the beam emerging from the MLP 12 exit aperture 14. Assuming that the MLP is a prism, i.e. all its walls are parallel to a central axis 16 (FIGS. 1b, 1c), it can be proven out of simple geometrical considerations, that a beam entering the MLP 12 at a certain angle with respect to the axis 16, will exit the MLP at the same angle with respect to the axis 16, but with altered direction due to the MLP scrambling effect. In other words, the numerical aperture at the MLP exit will be equal in all directions and will be NAₒ=NAᵢ, and hence

$${NA}_{im} = \frac{{NA}_{i}}{K} .$$

It is therefore apparent that for achieving bigger depth of focus, the designer's goal will be to work with as low as possible NAᵢ and as low as possible MLP 12 dimension a, allowing for higher K values. The minimum value for a is determined by the beam divergence in the slow axis direction and the distance d between the IALDA 20 and the MIA 10 (FIG. 1), and it is obviously achieved when d≅0. In this case, all energy emitted by the emitter will enter the MLP, but also NAᵢ will have its maximum value corresponding to the emitter's beam divergence in the fast axis direction. In other words, working with a low numerical aperture and accommodating all emitted energy are contradictory conditions in the embodiment of FIG. 1a-1c. Depending on the specific requirements of the optical system, a compromise between these two parameters should be made. As an example, in the optical system of FIGS. 1a-1c the cross sectional dimension a of the MLPs is chosen to be approximately the length l of the LD emitters, while the NAᵢ is chosen to correspond to the FWHM divergence angle of the LD in the emitter's slow axis direction. The latter is done by proper choice of the IALDA-MLPA distance d and the MLPs' cross sectional dimension h: NAᵢ=sin(atan(h/d)). It is important to point out that the minimum value for h depends also on the mutual displacement of the emitters 21 in the fast axis direction (often call “smile” of the array—dashed lines 21a in FIG. 1a). This configuration, however, is far from being optimal, because, as mentioned above, the fast axis divergence angle is much larger than the slow axis one, and all the energy emitted in this direction outside NAᵢ is lost

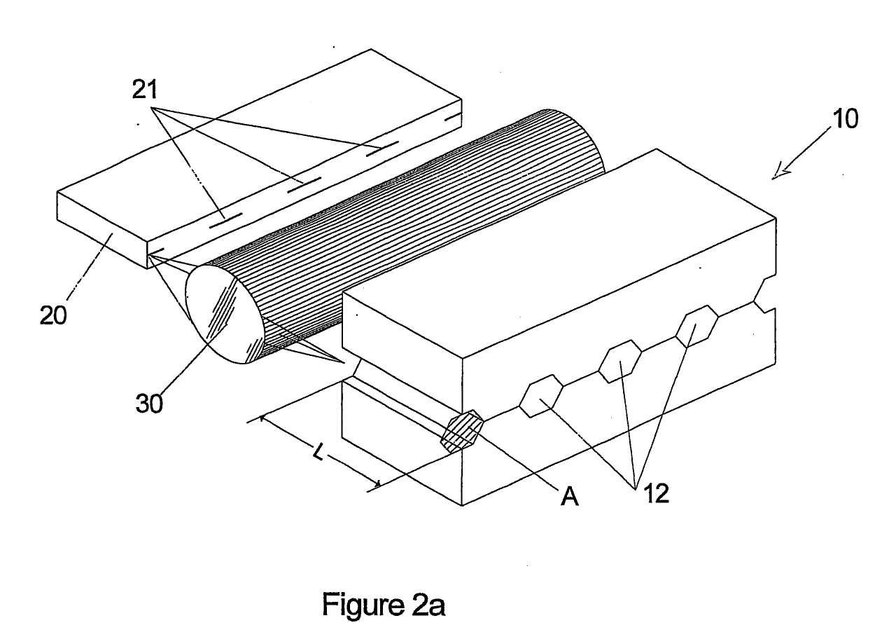

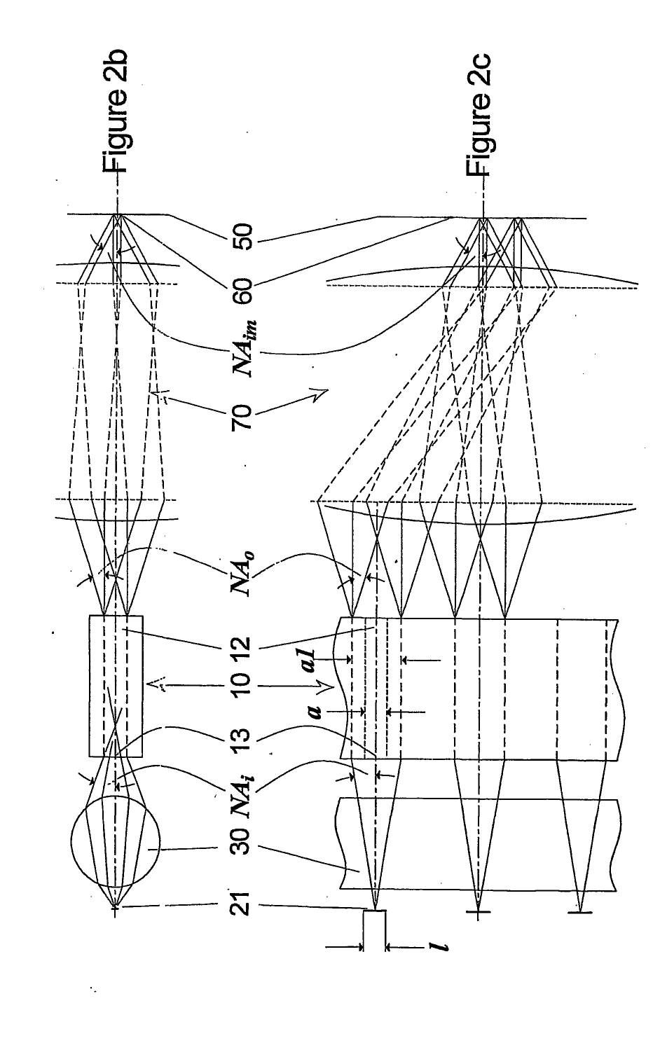

The loss of energy described above is avoided, to a great extent, in the optical system presented in FIGS. 2a, 2b and 2c.

FIG. 2a is a schematic isometric view of an IALDA 120 with anamorphic correcting lens 130 and beam-shaping MLPA 110. The difference between the systems of FIG. 1a and FIG. 2a is in the lens 130, placed between the IALDA 120 and the MLPA 110. For simplicity of the illustration, a cylindrical lens is shown. It will be, however, appreciated by any person skilled in the art, that anamorphic lenses of different types can be used with the same success. The function of the anamorphic lens 130 in the optical system is illustrated in FIGS. 2b and 2c, which are illustrations of the beams propagation in an optical imaging head 105, in a plane coinciding with the fast axis direction, and the beams propagation in a plane coinciding with the slow axis direction, respectively. The power of the anamorphic lens 130 in the fast axis direction is chosen such that the beam divergence in the fast axis direction beyond the lens 130 will approximately equal the beam divergence in the slow axis direction (in FIGS. 2a and 2b both values are designated by NAᵢ). Thus, the numerical aperture NAᵢ of the beam that enters the MLP 112 entrance aperture 113 contains most of the energy emitted by the diode. In FIGS. 2a-2c, the lens 130 is chosen to be common for all the emitters of the array. It will be, however, appreciated by any person skilled in the art, that other solutions may be implemented, for example a micro-lens array. Since the role of the lens 130 is only to decrease the beam divergence in the fast axis direction and to direct as much energy as possible to the MLP for a given NA, no constraint for imaging with minimum optical aberrations are placed here. This makes the design of the system easy and flexible in the choice of the lens 130.

The imaging lens 170 is preferably telecentric and images the exit apertures 114 of the MLPs 113. As the apertures 114 are substantially identical objects with very even spatial energy distribution, their resulting images 160 on the photosensitive medium 150 will also be substantially identical with even spatial energy distribution.

The system of FIGS. 2a-2c still does not provide optimum performance in terms of efficiency. Adding the lens 130 increases the distance d (FIG. 2a) between the IALDA 120 and the MLPA 110. Therefore, as can be seen in FIG. 2c, it is necessary to increase the cross-sectional dimension a of the MLP array to a value a>l+2d.NAᵢ, in order to accommodate the entire energy emitted in the slow axis direction. This increased dimension is marked as a1 and leads to a higher demagnification ratio (smaller K) of lens 170, hence to a larger image size numerical aperture NAᵢₘ and a reduced depth of focus. The minimum value for the cross sectional dimension h is determined by the array smile and the magnification of the anamorphic lens 130; the spot 121b produced by lens 130 from the most displaced emitter 121a, should be within the entrance aperture 113a of the corresponding MLP (FIG. 2a).

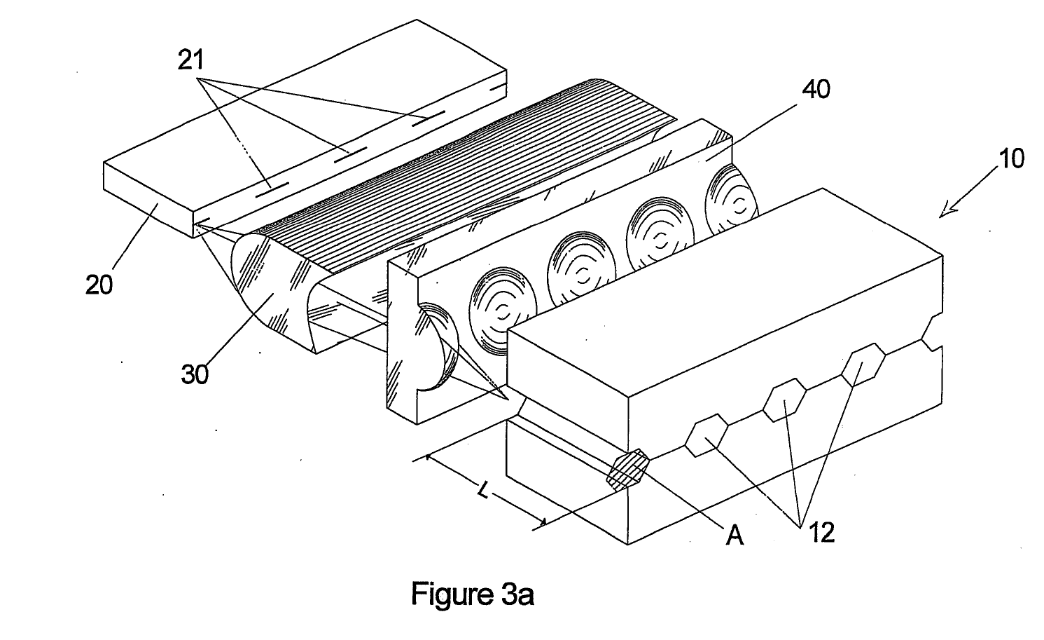

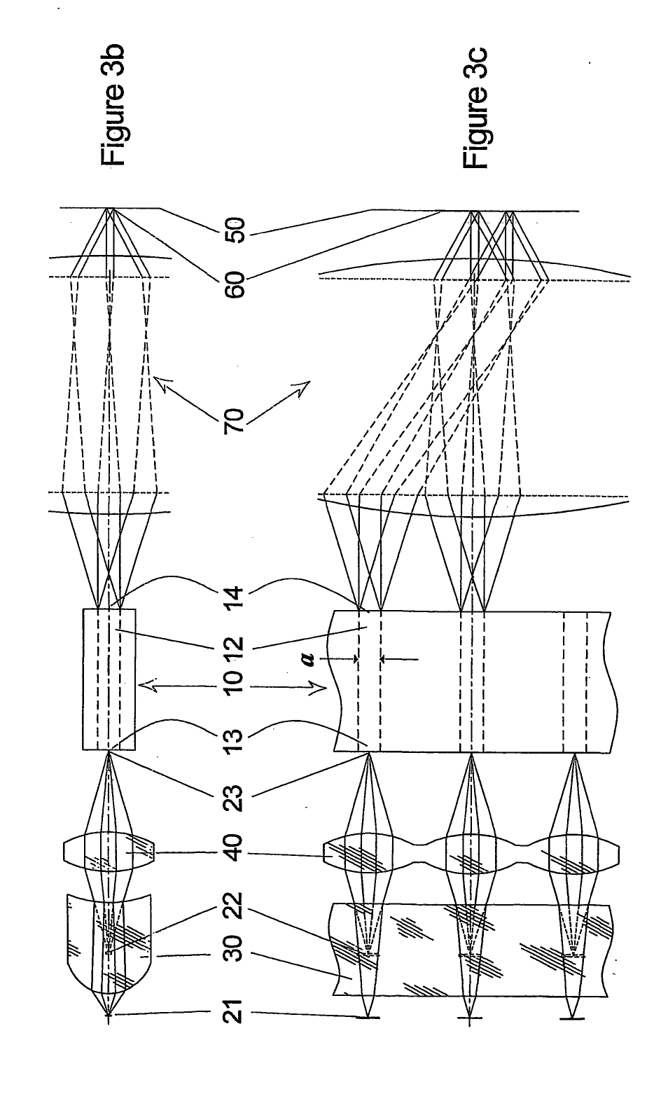

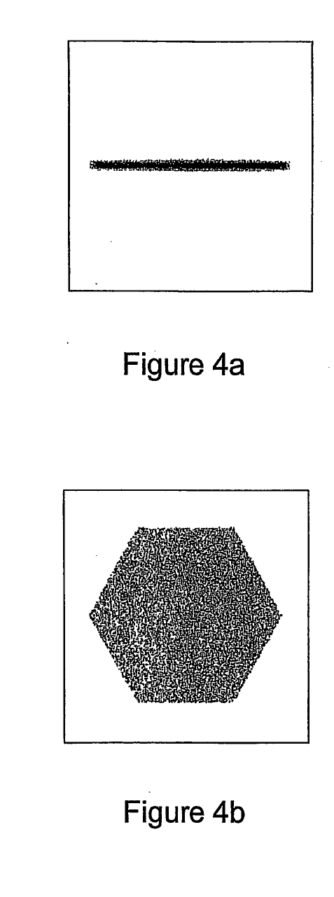

The increase in the cross sectional dimensions a of the MLPs, which is necessary in the system of FIGS. 2a-2c for collecting the entire emitted energy, can be avoided by employing an optical system that produces an image of the emitters in close vicinity to the entrance aperture of the MLPs. Because of the emitter's different beam divergence in the fast and slow axis directions, such system should have different power in these two directions. In the examples below (FIGS. 3a-3c and 4a-4c), the numerical aperture of the beam NAᵢ at the entrance of the MLP is chosen to be approximately identical in all directions and approximately equal to the numerical aperture NAₛ of the emitter in the slow axis direction: NAᵢ≅NAₛ. From the preservation of Etendue principle, it follows that the magnification in the slow axis direction will be approximately 1, while the magnification in the fast axis direction will be approximately NA_{f}/NAₛ>1. The emitters' image length l1 (FIG. 3c) will equal approximately the emitters' length l, and from considerations of preserving the brightness it will follow that the MLPs' dimension a in the slow axis direction will be: a≅l 1≅l. It will be appreciated by any person skilled in the art that other efficient configurations are also possible: a≅l 1<l; NAᵢ>NAₛ or a≅l 1>l; NAᵢ<NAₛ. The designer, however, should bear in mind that the numerical aperture NAₒ of the beam exiting the MLP will be identical in all directions and will correspond to the maximum angle of the entrance beam with respect to the MLPs' axis, and in conjunction with the magnification K of the imaging lens 270, will determine the system's depth of focus.

FIG. 3a is a schematic isometric view of an optical system consisting of an IALDA 220, an anamorphic correcting lens 230, a lenslet array 240 and a understood with the help of FIGS. 3b and 3c, which are illustrations of the beams propagation in an optical imaging head 200, in a plane coinciding with the emitter's fast axis direction, and the beams propagation in a plane coinciding with the emitter's slow axis direction, respectively: The anamorphic lens 230 is designed so as to create virtual images 222 of the LD emitters 221. Because of the anamorphic properties of the lens 230, the NA beyond the lens (designated by NAᵥ in FIGS. 3b, 3c) is identical in all directions perpendicular to the system axis of symmetry. The virtual image 222 serves as an object for lens 240, which produces a real image 223 in the vicinity of the entrance aperture 213 of the MLP 212. Because of the imaging properties of the lens combination 230-240 and the controlled NA, the dimensions of the image 223, as explained above, can be made to equal the MLP dimension a. Thus, the energy losses are minimized and no increase in the MLP cross sectional dimension is required.

The anamorphic lens 230 can be produced by extrusion, a method used by Bluesky Research Inc., of San Jose, Calif. The imaging lens 270 is preferably telecentric and images the exit apertures 214 of the MLPs 212. As the apertures 214 are substantially identical objects with a very even spatial energy distribution, their resulting images 260 on the photosensitive medium 250 will also be substantially identical, with an even spatial energy distribution.

The minimum value for the cross sectional dimension h of the MLP's 212 is determined by the array smile and the magnification of lens system 230-240 in the fast axis direction; the image 221b of the most displaced emitter 221a should be within the entrance aperture 213a of the corresponding MLP (FIG. 3a). It will be understood that some loss of energy will occur for displaced emitters. This loss can be compensated by choosing the individual emitters' working regimes such as to obtain the same power yield for each channel of the optical head 200.

Another system producing an image of the emitters in proximity to the MLP entrance aperture is illustrated in FIGS. 4a-4c. Here, the anamorphic lens 330 has its focal plane approximately coinciding with the entrance aperture 313 of the MLP and decreases the numerical aperture in the fast axis direction to a value close to the numerical aperture in the slow axis direction. The array 340 is an array of anamorphic lenses with power only in the slow axis direction. For each emitter 321, there is a member 341 of the array 340 associated with it. The imaging planes of anamorphic lenses 330 and 340 coincide. Thus, a real image of the emitter 321 is produced in close vicinity to the MLP entrance aperture 313, with numerical aperture approximately identical in all directions.

It will be also appreciated that the same optical effect can be achieved by designing the lens 340 not as a lenslet array, but as an assembly of bulk optical elements. It will also be appreciated that the anamorphic lens 330 and the focusing lens 340 can be combined in a single lenslet array of anamorphic elements. As in the previously described systems, the imaging lens 370 is preferably telecentric and images the exit apertures 314 of the MLPs 312. As the apertures 314 are substantially identical objects with very even spatial energy distribution, their resulting images 360 on the photosensitive medium 350 will also be substantially identical with even spatial energy distribution. The minimum value for the cross sectional dimension h of the MLPs 312 is determined by the array smile and the magnification of lens system 330-340 in the fist axis direction; the image 321b of the most displaced emitter 321a should be within the entrance aperture 313a of the corresponding MLP (FIG. 4a). The loss of energy due to the displacement can be compensated, as in the previously described systems, by choosing the individual emitter's working regimes such as to obtain the same power yield for each channel of the optical head 300.

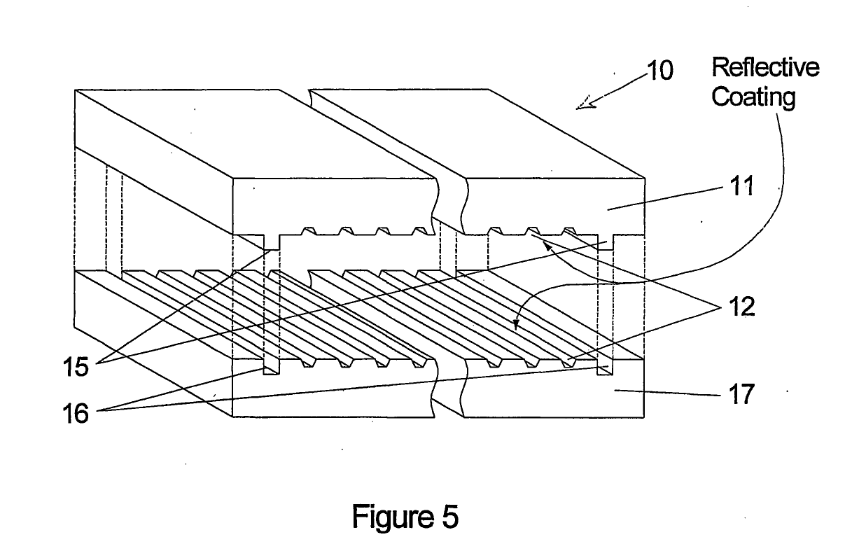

Reference is now made to FIGS. 5a and 5b, illustrating the light scrambling of the optical system of FIGS. 4a, 4b and 4c. FIG. 5a shows the light distribution in the real image 323 of LD emitter 321, in the entrance aperture 313 of the MLP 312. The length of emitter 321 in this example was 80 microns and the diameter of the aperture 313 was also chosen to be 80 microns. The MLP was chosen to be with a hexagonal cross section and with length L=1.5 mm. FIG. 5b shows the energy distribution in the same MLP exit aperture 314. It is obvious, that as far as the spot 360 on the photosensitive medium 350 (FIGS. 4b and 4c) is an image of the MLP exit aperture 314, the light energy distribution in it will be similar to that in the aperture 314, i.e. relatively uniform. Same results can be obtained with the optical systems of FIGS. 1a-1c, 2a-2c, and 3a-3c.

In all the previous embodiments, the MLP used is a prism, i.e. it does not alter the beam angle with respect to the optical axis. There is another type of light-pipe, known as tapered, which can be used not only for scrambling the light energy, but also for altering the numerical aperture of the beam. These light-pipes have a shape of a truncated pyramid, tapered in one or more directions. In the direction in which the light-pipe is tapered, the beam angle with respect to the axis will be changed.

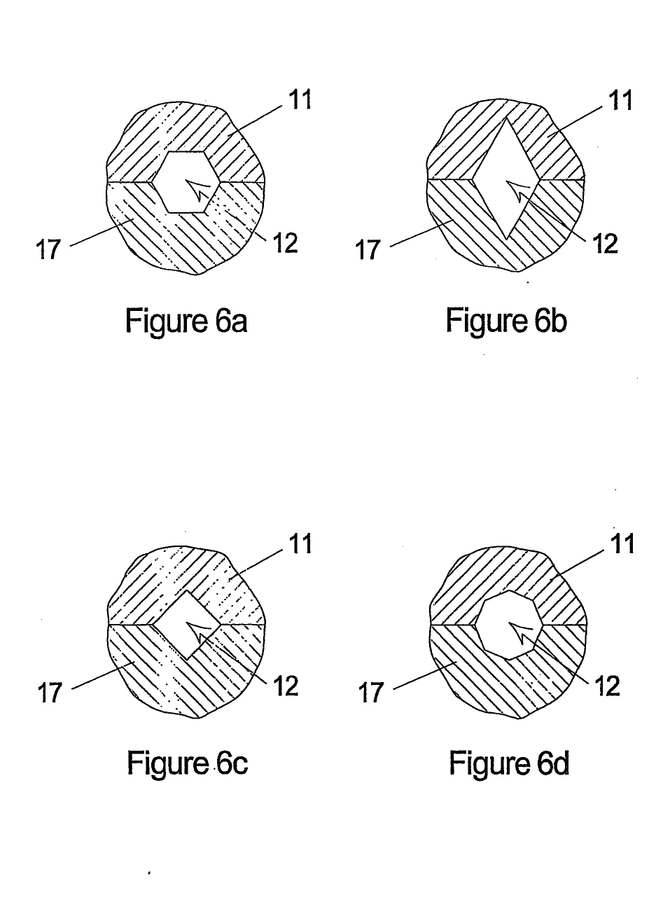

Reference is now made to FIG. 6a, presenting an IALDA 420, working in conjunction with a MLPA 410 of tapered MLPs 412. The dimension h1 of the MLP 412 entrance aperture 413 and the corresponding dimension h2 of the exit aperture 414, are chosen to be different: h1<h2. Thus, because the MLPs 412 are tapered in the fast axis direction, the fist axis numerical aperture NA_{f1} of the beam at the entrance of the MLPs will be decreased at the exit to a value

$${NA}_{f2} = {NA}_{f1} \frac{h1}{h2} .$$

Thus, by proper choice of h1, the numerical aperture of the beam at the exit aperture 414 can be made identical in all directions. The embodiment of FIG. 6a can be integrated in an optical imaging head 400, shown in FIGS. 6b and 6c. The possibility of altering the beam's numerical aperture, allows for choosing the MLPs' dimension in the slow axis direction a=l, where l is the emitter length and for minimizing the IALDA−MLPA distance d≅0 without loss of energy due to system geometry and without loss of depth of focus, in contrast to the optical head of FIGS. 1a-1c.

The optical imaging head of FIGS. 6a-6c is an improved variant of the imaging head of FIGS. 1a-1c. In this embodiment, however, there still could be significant energy losses. Because of the high entrance NA in the fast axis direction, the beam experiences more reflections in a tapered MLP than in a regular MLP, which leads to increased losses of energy in the reflective coating. If the tapered MLPs are of bulk-type, then the high entrance numerical aperture can lead to unfulfilled conditions for TIR and hence, once again, to energy losses.

These drawbacks of the previously described embodiment are avoided in the system presented in FIGS. 7a-7c, which is an improved variant of the embodiment of FIGS. 2a-2c. In this preferred embodiment, the MLPs 512 of the array 510 are designed as ‘funnels’, consisting of two parts, I and II, with lengths L1 and L2 respectively, as shown in FIG. 7a. Part I is a tapered MLP with entrance aperture 513, with dimensions l1×h1 in the fast and slow axis directions respectively, and exit aperture 515 with dimensions l2×h2 in the fast and slow axis directions respectively. Part II is a regular MLP with identical entrance and exit apertures, 515 and 514 respectively. Imaging head 500, with array 510 of funnel type MLPs, illustrates the beam propagation in the fast axis direction. The correcting anamorphic lens 530 reduces the beam NA in the fast axis direction to a value approximately equal to the NA in the slow axis direction: NA_{f}≅NAₛ and images the emitter 521 in close proximity to the part I of the MLP 512 exit aperture 515. The dimension h1 of the part I entrance aperture in the fast axis direction and the tapering angle α are chosen such that the MLPs in this part do not alter the NA in the fast axis direction, but allow for accommodation of the entire energy emitted in this direction, even when the emitter is displaced to some extent in vertical direction. Part I of the MLPs does not scramble the light in the fast axis direction. The light in this direction is scrambled by part II of the MLPs. The length L1 is chosen so that at the given angle α, the resulting height at aperture 515 is h2. h2 is a parameter determining the spot 560 dimension on the photosensitive medium 550 in the fast axis direction.

FIG. 7c illustrates the beam propagation in the slow axis direction. The dimension l1 of the part I entrance aperture in this direction is chosen such that the MLPs in this part accommodate the full energy emitted in numerical aperture NAₛ, accounting for the beam divergence and the distance between the IALDA 520 and the MLPA 510. Thus, the distance between the correcting anamorphic lens 530 and the MLPA 510 can be made approximately zero: d≅0. The light in this direction is scrambled in both parts I and II of the MLPs. The tapering angle β can be chosen to be zero and in this case l1=l2 and the full energy is accommodated with loss of brightness in this direction. If β is not zero, then l1≠l2 and the NA in this direction is altered by factor l1/l2 and there is once again a loss of brightness. As far as l1 depends on the distance d1 between the IALDA 520 and the MLPA 510, it is advisable to use correcting lens 530 with as small as possible cross section dimension, for example Luneburg type lens with diameter 60μ to 100μ produced by DORIC LENSES of Canada

Production Method

Hollow MLPAs can be produced by using standard photolithography technology on silicon wafers, or deep X-ray lithography on polymers. Both technologies are well mastered in many companies around the world, for example in the Institute for Micromechanics in Mainz, Germany or MicroDevices Inc of Radford, Va.

FIG. 8 is an exploded isometric view of a MLPA 610. The array consists of two base plates 617 and 611, in which half-hexagonal grooves are etched. The grooved surfaces are coated with a highly reflective coating, for example enhanced aluminum or bare gold, depending on the LD wavelength. The mechanical keys 615 and 616 are formed by the same photolithography process and are used for easy alignment of the two parts 617 and 611. By etching along the Si crystallographic planes, a diamond-like shape can be achieved as illustrated in FIG. 9b.

Other shapes can be achieved and other materials can also be used. For example, shapes as illustrated in FIGS. 9a, 9c and 9d, as well as non-symmetrical shapes can be made by using lithography or micro-molding techniques.

An additional method for producing MLPAs is by shaping a coherent bundle of optical fibers. This technology involves the steps of:
1. Arranging the fibers in a coherent bundle;
2. Heating the bundle to a predetermined temperature; and
3. Extrusion under predetermined pressure.

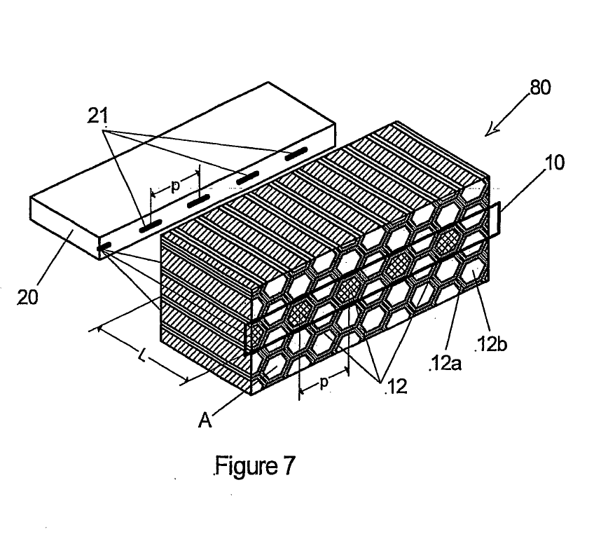

This technology is mastered for example in Schott Optical Fibers of Germany (www.schott.com). The resulting optical element is a coherent bundle of optical fibers with hexagonal cross-section. Such optical elements are usually used as image tapers or extenders. However, if a thin plate of the bundle is cut-off and optically polished on both sides, it can be used as an MLPA, as illustrated in FIG. 10. The initial dimensions of the fibers' cladding 712a and core 712b and the production process parameters (temperature, pressure, extrusion, etc.) are chosen such as to achieve a certain distance p between each two or three or four, etc. fibers, to match the pitch of emitters 721 of IALDA 720. Thus, a small number (cross-hatched) of elements 712 in the cut-off plate 700 constitute the MLPA 710.

Another method of producing MLP is by means of standard glass technology, to form macro rods with desired cross section shape and then by extrusion to reduce the cross sectional dimension to a desired value. Such techniques are widely used for producing anamorphic lenses with small cross sectional dimensions.

Optical imaging heads incorporating IALDA and MLPA can be used, as mentioned hereinabove, in electro-optical plotters for offset plates, laser transfer mediums, etc. FIG. 11 illustrates the basic design of such electro-optical plotter. The photosensitive medium (offset plate, etc.) 801 is wrapped around a rotating drum 800. Optical head 804, incorporating IALDA and MLPA, produces a plurality of spots 803 on the photosensitive medium 801. The drum rotates with substantially constant speed in the direction shown by arrow 805, while the optical head 804 moves parallel to the drum axis (not shown) in the direction marked by arrow 806. The system is driven by a central processor 809, which by means of control unit 807 synchronizes the two movements 806 and 805, and the data transfer between the image data bank 808 and the optical head 804. The digital equivalent of the image to be written on the photosensitive medium is stored in the image data bank 808, from where it is transferred to the optical head 804, which by means of producing a plurality of light spots 803 on the photosensitive medium 801, forms the desired image 802.

FIG. 12 illustrates an electro-optical plotter of flatbed type, with optical head 903 incorporating IALDA and MLPA. The photosensitive medium 904 is placed on a flat surface of an X-Y scanning engine 900. The digital equivalent of the image to be written on the photosensitive medium is stored in the image data bank 808, from where it is transferred to the optical head 903, which by means of producing a plurality of light spots 901 on the photosensitive medium 904, forms the desired image 902. The scanning movement of the optical head 903 in two perpendicular direction 905 and 906, is controlled by a central processor 809, through control unit 807. The CPU 809 also synchronizes the data flow from the image data bank 808 to the optical head 903 with the scanning movements 905 and 906.

1. An optical imaging head comprising:
an array of multi-mode laser diode emitters;
an array of micro light-pipes (MLPs), each of said individual micro light-pipes being associated with one of said laser diode emitters; and
means for imaging the exit aperture of each of said micro light-pipes on a photosensitive medium.

2. An optical imaging head according to claim 1, wherein said means for imaging comprises a telecentric lens.

3. The optical imaging head of claim 1, additionally comprising means for reducing the divergence of the laser diode beam in the fast axis direction.

4. The optical imaging head of claim 3, wherein said means for reducing the divergence is an anamorphic lens.

5. The optical imaging head of claim 4, wherein said anamorphic lens is cylindrical.

6. The optical imaging head of claim 3, wherein said means for reducing the divergence is common for all said laser diode emitters.

7. The optical imaging head of claim 3, wherein said means for reducing the divergence is separate for each of said laser diode emitters.

8. The optical imaging head of claim 7, wherein said means for reducing the divergence is a micro-lens array.

9. The optical imaging head of claim 1, additionally comprising means for imaging the laser diode emitters on a surface close to the micro light-pipe entrance aperture.

10. The optical imaging head of claim 1 wherein the micro light-pipes are tapered.

11. The optical imaging head of claim 3 wherein the micro light-pipes are of funnel type.

12. An external-drum electro-optical plotter comprising the optical head of claim 1.

13. A flatbed electro-optical plotter comprising the optical head of claim 1.

14. A method of producing a plurality of writing spots on a photosensitive medium, comprising the steps of:
providing an array of multi-mode laser diode emitters;
providing an array of micro light-pipes, each of said individual micro light-pipes being associated with one of said laser diode emitter; and
imaging the exit aperture of each of said micro light-pipes on said photosensitive medium.

15. The method of claim 14, additionally comprising, before said step of imaging, the step of providing means for reducing the divergence of the laser diode beam in the foist axis direction.

16. The method of clam 15, additionally comprising, after said step of providing means for reducing the divergence of the laser diode beam in the fast axis direction, the step of imaging the laser diode emitter in a surface close to the micro light-pipe entrance aperture.
